(19) United States
(12) Patent Application Publication
(10) Pub. No.: US 2006/0239879 A1
(43) Pub. Date: Oct. 26, 2006

(54) Acid gas pretreating method

(76) Inventors: Francois Lallemand, Morlaas (FR); Fabrice Lecomte, Paris (FR); Eric Lemaire, Morance (FR); Xavier Renaud, Boeil Bezing (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/389,113

(22) Filed: Mar. 27, 2006

(30) Foreign Application Priority Data
Mar. 31, 2005 (FR) 05/03.266

(51) Int. Cl. B01D 53/46

(52) U.S. Cl. 423/210

(57) ABSTRACT

The method allows pretreatment of an acid gas that can comprise more than 10% H₂S, for example a natural gas or a gas associated with the production of a crude petroleum effluent.

The gas is dehydrated in unit DH, then cooled by heat exchangers E9 to E12 and by expansion carried out through valve V7. Cooling allows part of the H₂S contained in the gas to be condensed. The condensates are separated from the gas in drum B1.

The liquid recovered at the bottom of drum B1 is pumped and injected into well P to be sequestered in an underground reservoir or a geologic structure. The gas discharged at the top of drum B1 is depleted in H₂S. This gas is sent through line 43 to a treating site in order to be subjected to additional treatments prior to being used.

### FIELD OF THE INVENTION

The invention relates to a method for pretreating an acid gas, i.e. a gas containing high proportions of acid compounds, notably hydrogen sulfide (H₂S), carbon dioxide (CO₂), carbon oxysulfide (COS) and mercaptans.

The present invention can be used for treating a natural gas or a gas associated with a petroleum effluent produced on the site of an oil reservoir, in particular sites that are not very accessible or offshore platforms.

When the production of oil reservoirs is started, the crude petroleum effluent is roughly stabilized, i.e. separated from its associated gas, prior to undergoing an additional finishing treatment in order to be marketed.

In this type of production, the associated gas, when it contains high proportions of acid gases, notably H₂S (typically more than 10% by mole H₂S), is generally difficult to exploit and can be partly reinjected on the production site into an injection well.

The present invention is within the context of the use of part of this associated gas as fuel to provide power to installations, for example on offshore platforms, and also onshore where additional treating processes can be implemented. This use poses the problem of the treatment of this associated gas in order to be able to use it as fuel.

### BACKGROUND OF THE INVENTION

In the case of weakly acid gases, conventional treatments can be used directly, even on platforms:

When the gas contains a very low proportion of sulfur (less than 100 kg sulfur/day), scavenger type methods can be used.

When the sulfur content of the gas to be treated does not involve a sulfur production above 10 tons/day, a redox type method can be used, as described in patent FR-2,771,945.

It can however be noted that these two technologies produce solid sulfur that has to be stored, then eliminated.

When the gas to be treated contains some percents by mole of H₂S, methods using amines are generally implemented. These methods have the drawback of producing gaseous H₂S at low pressure, thus requiring several recompression stages for reinjection into the reservoir.

When the associated gas contains more than 10% by mole of H₂S, conventional treatments are no longer economically advantageous, notably on offshore platforms.

It may then become necessary to transport the associated gas onshore for treatment, then to send it back to the platform to be used as fuel. This solution is not very advantageous considering that the production of very acid fields is often associated with reinjection of the acid gases into the reservoir in order to limit the treatment costs (Claus process, Claus tail gas treatment) and the production of sulfur associated with these treatments. Onshore separation of the associated gas and of the H₂S generates a very acid effluent that has to be either sent back to the platform to be reinjected or treated onshore, thus producing solid sulfur that is difficult to exploit.

The present invention provides a gas pretreating method that notably allows to concentrate the H₂S in order to reinject it on the production site and to facilitate additional gas treatments in order to obtain a usable fuel gas while limiting fluid transfers between the production zone (offshore for example) and the treatment zone (onshore for example).

### SUMMARY OF THE INVENTION

The present invention relates to a method for treating a hydrocarbon gas, said gas comprising at least one of the acid compounds as follows: hydrogen sulfide (H₂S), carbon dioxide (CO₂), carbon oxysulfide (COS) and mercaptans, wherein the following stages are carried out:

a) dehydrating the gas,

b) cooling the dehydrated gas to a temperature at which part of the acid compounds condense, so as to obtain an effluent comprising a liquid fraction rich in acid compounds and a gaseous fraction depleted in acid compounds,

c) sending the effluent to a separation zone so as to separate the liquid fraction from the gaseous fraction,

d) injecting at least part of the liquid fraction rich in acid compounds into an underground storage zone, an underground reservoir or a geologic formation for example.

In the method according to the invention, in stage a), the gas is dehydrated so that the water dew point temperature of the dehydrated gas at the operating pressure of the separation zone is higher by at least 15° C. than the minimum temperature of said effluent in the separation zone.

According to the invention:

said gas can be at a pressure ranging between 30 and 120 bar absolute,

the water content of the dehydrated gas obtained in stage a) can be below 50 ppm,

in stage b), the dehydrated gas can be cooled to a temperature ranging between −90° C. and −20° C.

According to the invention, additional deacidizing of the gaseous fraction obtained in stage c) can be carried out by absorption of the acid compounds by an absorbent solution and/or by adsorption of the acid compounds on a molecular sieve. Furthermore, the deacidized gaseous fraction can be dehydrated.

In stage c), the separation zone can use one of the following means: distillation column, separator drum. If the separation zone is a distillation column, part of the gaseous fraction from the distillation column can be condensed by cooling, then fed into the column as reflux.

In stage b), the gas can be cooled by means of at least one of the following methods: heat exchange and expansion.

Prior to stage d), the pressure of said at least part of the H₂S-rich liquid fraction can be raised by pumping.

According to the invention, the hydrocarbon gas can be a gas associated with a crude petroleum effluent and, prior to stage a), the crude petroleum effluent and the associated gas can be separated. Prior to separation, the crude petroleum effluent can be expanded and/or cooled before it is separated from the associated gas. The crude petroleum effluent can be extracted from an offshore oil structure and the gaseous fraction can be deacidized in an onshore treating zone. The deacidized gaseous fraction can be sent back to the platform to be used as fuel.

In this case, the present invention allows to significantly limit the proportion of acid compounds sent onshore with the associated gas by performing a pretreatment of this associated gas on the platform prior to sending it onshore for a finishing treatment. Furthermore, pretreatment of the gas consequently allows to limit the proportion of gas to be treated onshore. Besides, another advantage of the invention lies in the fact that the acid gases separated by pretreatment are produced at high pressure in liquid form, which allows them to be reinjected into an underground reservoir or a geologic formation at a lower cost by simple pumping.

### BRIEF DESCRIPTION OF THE FIGURES

Other features and advantages of the invention will be clear from reading the description hereafter, with reference to the accompanying figures wherein:

FIG. 1 shows a crude petroleum effluent treating chain,

FIGS. 2 and 3 diagrammatically show two embodiments of the associated gas pretreating method,

FIGS. 4 and 5 show a complete associated gas treating chain.

### DETAILED DESCRIPTION

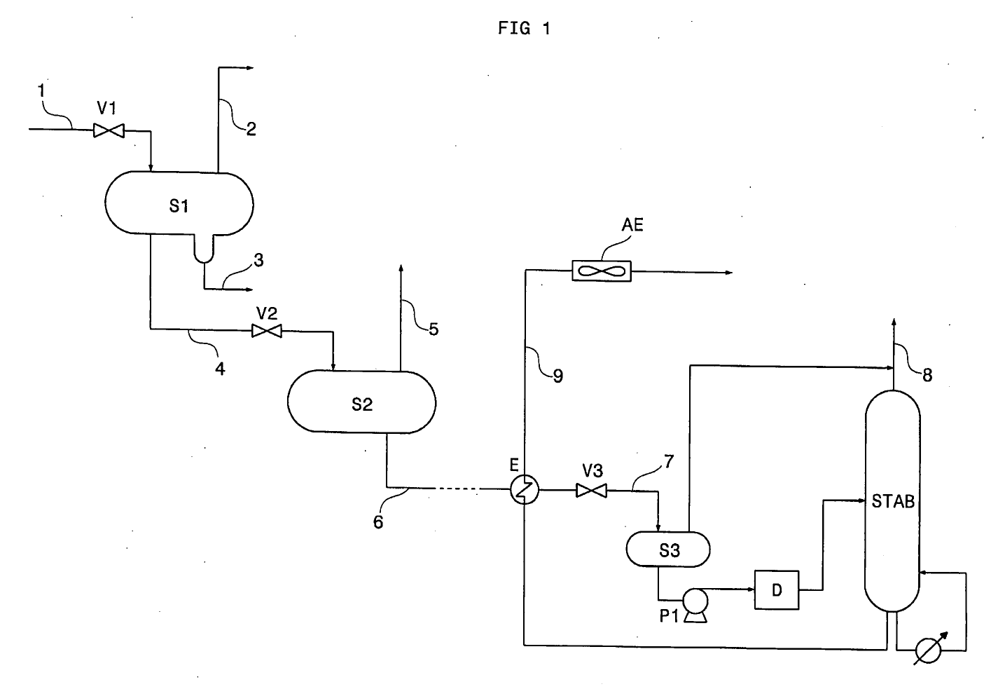

In FIG. 1, the crude petroleum effluent produced at the wellhead flows in through line 1. This effluent is expanded by expansion means V1, then fed into separation device S1. Expansion means V1 can be a valve or a combination of valves. Expansion allows to release in gaseous form the light hydrocarbons and acid compounds such as H₂S, CO₂, COS and mercaptans. Device S1 works at high pressure typically ranging between 40 and 120 bar absolute. It allows separation into three phases: associated gas, oil and water. At the top of separator S1, a high-pressure associated gas is recovered through line 2. The water is discharged from separator S1 through line 3.

The oil separated in device S1 is discharged through line 4, expanded by expansion means V2 and fed into separation device S2 operating at medium pressure, typically between 10 and 60 bar absolute. In device S2, a medium-pressure gas and a liquid effluent are separated and discharged through lines 5 and 6 respectively. This liquid effluent is heated in heat exchanger E, typically between 30° C. and 80° C.

Then, the effluent is expanded by expansion means V3 and sent to a low-pressure separation device S3. A liquid and a gas are separated in device S3. The liquid from separator S3 is pumped by pump P1, then freed of the salt it contains by treatment in desalting unit D. The desalted liquid is thereafter sent to the top of stabilization column STAB equipped with a reboiler at the bottom thereof.

The stabilized crude oil is recovered at the bottom of column STAB, cooled in exchanger E, then exported or stored after passing through an air-cooled exchanger AE for final cooling. The low-pressure associated gas recovered at the top of column STAB is mixed with the gas from S3. This gas mixture is discharged through line 8.

In the treating chain shown in FIG. 1, the separations carried out in devices S1 and S2 can be performed on an offshore platform. The liquid from separator S2 is sent to an onshore treating site through the agency of line 6. The rest of the treatment, i.e. separation, desalting and stabilization respectively carried out in device S3, in unit D and in stabilization column STAB, is performed downstream, onshore for example.

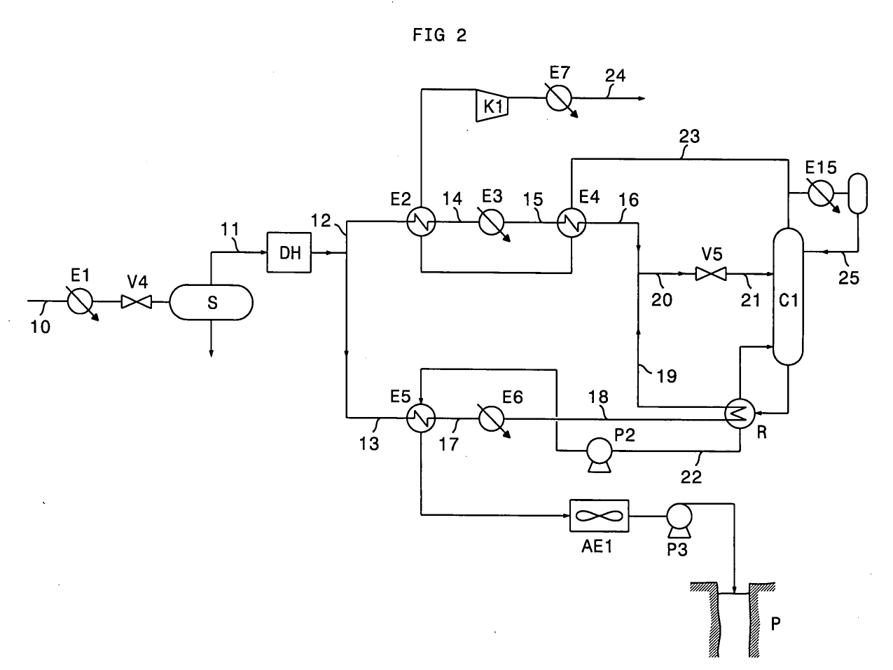

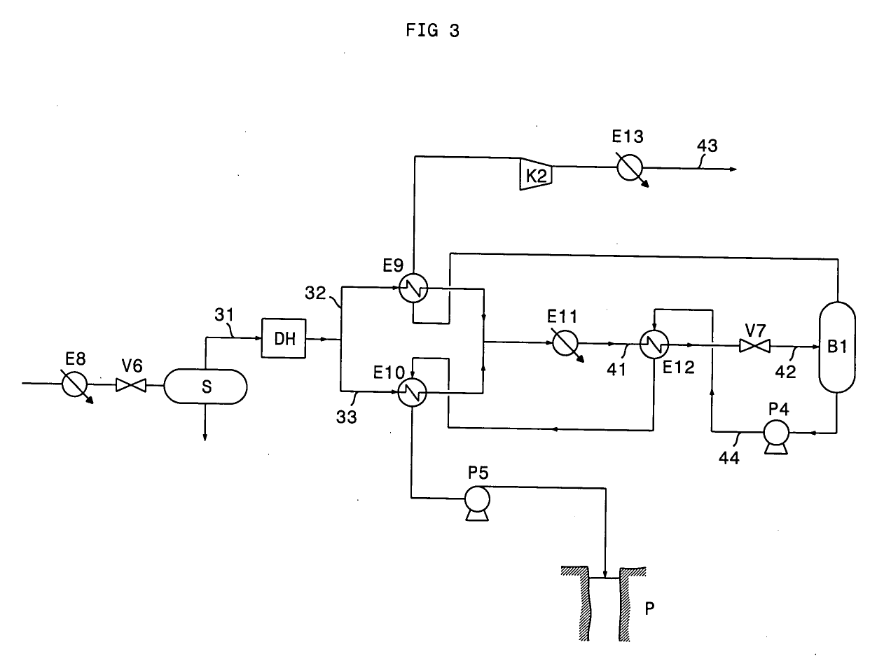

According to the invention, the associated gas circulating in line 2 and/or 5 is subjected to a pretreatment. Two embodiments of this pretreating method are described in connection with FIGS. 2 and 3.

In FIG. 2, the petroleum effluent flows in through line 10. It can be cooled in heat exchanger E1, then expanded in expansion means V4. Then, the petroleum effluent is separated in separation device S into two or three phases: an associated gas, oil and possibly water. The liquids are discharged at the bottom of separation device S, the associated gas is discharged through line 11. This associated gas circulating in line 11 can correspond to the gas circulating in line 2 and/or 5 of FIG. 1. This gas can be at a pressure ranging between 30 and 100 bar absolute, and at a temperature ranging between 0° C. and 60° C. The gas circulating in line 11 essentially comprises light hydrocarbons (methane, ethane and propane) and acid compounds such as H₂S, CO₂, COS and mercaptans. In particular, the gas can comprise more than 10% by volume of H₂S.

The associated gas circulating in line 11 is sent, partly or totally, to dehydration unit DH intended to remove part of the water it contains. The dehydration technique used can be selected from among the gas dehydration techniques known to the man skilled in the art that can lower the water dew point of the gas to temperatures compatible with those of the further stages of the method, typically at water contents below 50 ppm, preferably below 20 ppm and more preferably below 5 ppm by mole. These dehydration techniques can be gas scrubbing by means of a glycol solution such as diethylene glycol (DEG), triethylene glycol (TEG) or tetraethylene glycol. For example, the method described in document FR-2,740,468 can be used. For dehydration, it is also possible to implement one of the methods described in documents FR-2,715,692, FR-2,814,378 and FR-2,826,371.

Because of the presence of H₂S in the gas, the gas drying level in unit DH can be reduced in relation to the drying required for a gas comprising no H₂S. In fact, for a dried gas comprising no H₂S and comprising 6.8 ppm water, the water dew point at 44 bars is −44° C. Conversely, according to the invention, for the dried acid gas comprising 6.8 ppm water and 15% H₂S, the gas can be cooled to −66.5° C. at 44 bars to form a liquid phase and a gas phase, these phases being undersaturated with water at 62%. The steam is in fact considerably displaced towards the H₂S-rich liquid. In other words, for an equivalent drying level, the temperature of a gas comprising H₂S can be lower by about 20° C. than that of a dry gas comprising no H₂S, while keeping a significant safety margin as regards the appearance of an aqueous phase and the risk of hydrate formation. This margin can be amplified using a separation method based on a column with a condenser.

Thus, according to the invention, the gas is dehydrated in unit DH so that the water dew point temperature of the dehydrated gas under the pressure conditions of column C1 is higher by 15° C., preferably by 15° C. to 60° C., than the temperature of the coldest effluent in the separation zone, i.e. in column C1 in FIG. 2.

Part of the dehydrated gas can be directly injected into a well down to an underground reservoir or a geologic structure. In this case, the fluid dehydration level takes account of the fluid requirements in the circuit and in the injection well.

Part or all of the gas recovered at the dehydration unit outlet is then cooled, for example by several heat exchangers E2, E3, E4, E5 and E6. In FIG. 2, the gas is separated into two streams circulating in lines 12 and 13. The cold can be partly provided by recovery of the frigories of the pretreated gas (exchangers E2 and E4) and of the liquid effluent containing H₂S prior to its reinjection (exchanger E5). The cold can also be supplied by an outer source such as a refrigeration circuit using propane for example (exchangers E3 and E6). Furthermore, cooling can be performed partly by thermal integration at reboiler R of column C1. The stream circulating in line 12 is cooled by heat exchanger E2, then sent through line 14 into heat exchanger E3, fed through line 15 into heat exchanger E4 and discharged through line 16. The stream circulating in line 13 is cooled in heat exchanger E5, then sent through line 17 into exchanger E6, through line 18 to reboiler R in order to be cooled and discharged through line 19. The streams circulating in lines 16 and 19 are combined so as to circulate in line 20. At the outlet of the heat exchanger train, the temperature of the effluent circulating in line 20 can range between −80° C. and −10° C., preferably between −55° C. and −20° C. Its pressure is close to its initial pressure, minus the pressure drops linked with the various elements used in the method.

The effluent is then expanded in expansion means V5 so as to cause additional cooling. This expansion can be performed by isenthalpic expansion through a valve. According to circumstances, it can also be carried out by means of an expansion turbine, which allows to achieve deeper cooling with an equivalent expansion rate and to recover part of the expansion energy of the gas for further recompression for example. The pressure of the effluent after expansion can range between 20 and 90 bar absolute, preferably between 35 and 60 bar absolute. Its temperature can range between −90° C. and −20° C., preferably between −70° C. and −30° C.

Although the temperature of the separation zone is between 15° C. and 60° C. lower than the dew point temperature imposed by the dehydration carried out by DH, there is no ice or hydrate formation problem because of the presence of H₂S. Cooling and expansion of the gas performed by exchangers E2 to E6 and by expansion means V5 allow to reach the required thermodynamic conditions, i.e. temperature and pressure, allowing elimination of the proportion of acid compounds, in particular H₂S, sought in column C1. In fact, cooling allows to condense the acid compounds. When a very low cold level is reached, i.e. the effluent circulating in line 21 reaches temperatures below −40° C., preferably below −50° C., pretreatment has the advantage of removing the major part of the mercaptans present in the gas, thus sparing in most cases an additional treatment.

The cooled effluent is fed through line 21 to the top of distillation column C1 whose bottom is equipped with reboiler R. The reboiling heat can be supplied by heat exchange with the effluent flowing in through line 18. The number of stages of the column depends on the specifications to be reached for separation of the H₂S and of the hydrocarbons. Typically, column C1 can comprise 1 to 15 theoretical stages, preferably 3 to 8. Thus, column C1 allows to obtain, at the bottom, a liquid rich in acid compounds, notably H₂S and, at the top, gaseous hydrocarbons depleted in acid compounds, notably H₂S. The temperature at the top of the column can be controlled by a liquid reflux from the condensation, in exchanger E15, of part of the stream discharged at the top of column C1.

The methane yield can be improved by exploiting the power of reboiler R at the bottom of column C1. The more or less large number of plates is optimized so as to keep a correct selectivity between the additional methane and H₂S generated by reboiler R.

The treatment range can be limited in pressure and temperature by the crystallization range of the CO₂ or of the H₂S. The crystallization range varies depending on the composition of the feed fluid, but extension of the treatment to low temperatures is favoured by the method according to the invention: the presence of a condensate at the column inlet plays a favourable part because it dilutes the H₂S and the CO₂ in the liquid phase and it plays an active part in the liquid/solid equilibria.

The liquid from the bottom of column C1 is heated in reboiler R, then discharged through line 22 and pumped by pump P2. The liquid is thereafter heated by heat exchanger E5 by exchange with the effluent flowing in through line 13, then sent back to the recompression chain in order to be reinjected into well P down to an underground reservoir or a geologic structure. The underground reservoir or the geologic structure can be located close to the crude effluent production site. The injection pressure depends on the pressure of the reservoir or of the geologic structure; it can reach several hundred bars. For example, the circuit can comprise an air-cooled exchanger AE1 for heating the liquid flowing in through line 13, then it can be pumped by pump P3 and injected into well P.

The method according to the invention can be used in cases where the hydrocarbon yield is not a priority criterion. The gas can undergo hydrocarbon losses in the heavy fractions, typically the C3+, more condensable than H₂S. These condensed hydrocarbons are recovered with the H₂S at the bottom of column C1, then injected into well P.

The pretreated gas obtained at the top of separation column C1 is sent through line 23 into heat exchangers E4 and E2 to be heated by exchange with the feed effluent flowing in through line 12. This gas is then compressed by compressor K1, cooled by exchanger E7 (air-cooled exchanger for example), then sent to the finishing treatment, possibly onshore, by circulating in line 24.

Recompression of the gas by compressor K1 or pumping of the liquid by pumps P2 and/or P3 can be partly achieved by means of the energy supplied by turbine V5.

In order to illustrate the pretreating method described in connection with FIG. 2, an example of composition and of thermodynamic conditions of the streams circulating in the lines shown in FIG. 2 is given in Tables 1 and 2. In this example, the thermodynamic conditions of column C1 are so selected that the pretreated gas obtained at the top of separation column C1 comprises less than 10% of the molar proportion of H₂S contained in the gas circulating in line 11.

TABLE 1

| | Stream circulating in line | | | | | | | |
|---|---|---|---|---|---|---|---|---|
| | 11 | 12 | 13 | 14 | 15 | 16 | 17 | 18 |
| | PHASE | | | | | | | |
| | | | | Vapor/ | | | Vapor/ | |
| Fluid flow rate | | | | liquid | | | liquid | |
| in Kg mol/h | Vapor | Vapor | Vapor | mixture | Liquid | Liquid | mixture | Liquid |
| N2 | 397.6 | 198.8 | 198.8 | 198.8 | 198.8 | 198.8 | 198.8 | 198.8 |
| CO2 | 1544.0 | 772.0 | 772.0 | 772.0 | 772.0 | 772.0 | 772.0 | 772.0 |
| H2S | 4628.9 | 2314.4 | 2314.4 | 2314.4 | 2314.4 | 2314.4 | 2314.4 | 2314.4 |
| Methane | 19991.2 | 9995.6 | 9995.6 | 9995.6 | 9995.6 | 9995.6 | 9995.6 | 9995.6 |
| Ethane | 2525.7 | 1262.8 | 1262.8 | 1262.8 | 1262.8 | 1262.8 | 1262.8 | 1262.8 |
| Propane | 1096.6 | 548.3 | 548.3 | 548.3 | 548.3 | 548.3 | 548.3 | 548.3 |
| i-butane | 161.5 | 80.8 | 80.8 | 80.8 | 80.8 | 80.8 | 80.8 | 80.8 |
| Butane | 323.1 | 161.5 | 161.5 | 161.5 | 161.5 | 161.5 | 161.5 | 161.5 |
| i-pentane | 90.1 | 45.0 | 45.0 | 45.0 | 45.0 | 45.0 | 45.0 | 45.0 |
| Pentane | 93.2 | 46.6 | 46.6 | 46.6 | 46.6 | 46.6 | 46.6 | 46.6 |
| Hexane | 87.0 | 43.5 | 43.5 | 43.5 | 43.5 | 43.5 | 43.5 | 43.5 |
| Benzene | 9.3 | 4.7 | 4.7 | 4.7 | 4.7 | 4.7 | 4.7 | 4.7 |
| Heptane | 52.8 | 26.4 | 26.4 | 26.4 | 26.4 | 26.4 | 26.4 | 26.4 |
| Octane | 55.9 | 28.0 | 28.0 | 28.0 | 28.0 | 28.0 | 28.0 | 28.0 |
| H2O | 129.7 | 1.5 | 1.5 | 1.5 | 1.5 | 1.5 | 1.5 | 1.5 |
| Total flow rate | 31186.7 | 15530.0 | 15530.0 | 15530.0 | 15530.0 | 15530.0 | 15530.0 | 15530.0 |
| in Kg mol/h | | | | | | | | |
| Temperature, | 65.0 | 67.2 | 67.2 | 16.1 | −33.0 | −41.3 | 30.0 | −33.0 |
| in ° C. | | | | | | | | |
| Pressure | 95.0 | 95.0 | 95.0 | 94.0 | 93.0 | 92.0 | 94.0 | 94.0 |
| in bar abs. | | | | | | | | |

TABLE 2

| | Stream circulating in line | | | | | |
|---|---|---|---|---|---|---|
| | 19 | 20 | 21 | 22 | 23 | 24 |
| | PHASE | | | | | |
| | | | Vapor/ | | | |
| Fluid flow rate | | | liquid | | | |
| in Kg mol/h | Liquid | Liquid | mixture | Liquid | Vapor | Vapor |
| N2 | 198.8 | 397.6 | 397.6 | 42.6 | 355.1 | 355.1 |
| CO2 | 772.0 | 1544.0 | 1544.0 | 1223.1 | 320.9 | 320.9 |
| H2S | 2314.4 | 4628.9 | 4628.9 | 4166.0 | 462.9 | 462.9 |
| Methane | 9995.6 | 19991.2 | 19991.2 | 9330.4 | 10660.8 | 10661.6 |
| Ethane | 1262.8 | 2525.7 | 2525.7 | 2162.9 | 362.8 | 362.8 |
| Propane | 548.3 | 1096.6 | 1096.6 | 1043.2 | 53.5 | 53.5 |
| i-butane | 80.8 | 161.5 | 161.5 | 158.8 | 2.8 | 2.8 |
| Butane | 161.5 | 323.1 | 323.1 | 318.0 | 5.1 | 5.1 |
| i-pentane | 45.0 | 90.1 | 90.1 | 89.6 | 0.5 | 0.5 |
| Pentane | 46.6 | 93.2 | 93.2 | 92.7 | 0.5 | 0.5 |
| Hexane | 43.5 | 87.0 | 87.0 | 86.9 | 0.1 | 0.1 |
| Benzene | 4.7 | 9.3 | 9.3 | 9.3 | 0.0 | 0.0 |
| Heptane | 26.4 | 52.8 | 52.8 | 52.8 | 0.0 | 0.0 |
| Octane | 28.0 | 55.9 | 55.9 | 55.9 | 0.0 | 0.0 |
| H2O | 1.5 | 3.0 | 3.0 | 2.9 | 0.1 | 0.1 |
| Total flow rate | 15530.0 | 31060.0 | 31060.0 | 18835.0 | 12225.0 | 12225.8 |
| in Kg mol/h | | | | | | |
| Temperature, | −53.6 | −47.3 | −56.4 | −40.5 | −56.3 | 65.0 |
| in ° C. | | | | | | |
| Pressure | 93.0 | 92.0 | 55.0 | 150.0 | 55.0 | 95.0 |
| in bar abs. | | | | | | |

A second example of composition and of thermodynamic conditions of the streams circulating in the lines shown in FIG. 2 is given in Tables 3 and 4.

TABLE 3

| | Stream circulating in line | | | | | | |
|---|---|---|---|---|---|---|---|
| | 12 | 13 | 14 | 15 | 16 | 17 | 18 |
| | PHASE | | | | | | |
| | | | Vapor/ | Vapor/ | | Vapor/ | |
| Fluid flow rate | | | liquid | liquid | | liquid | Vapor/liquid |
| in Kg mol/h | Vapor | Vapor | mixture | mixture | Liquid | mixture | mixture |
| N2 | 120.1 | 223.0 | 120.1 | 120.1 | 120.1 | 223.0 | 223.0 |
| CO2 | 440.9 | 818.8 | 440.9 | 440.9 | 440.9 | 818.8 | 818.8 |
| H2S | 1261.8 | 2343.5 | 1261.8 | 1261.8 | 1261.8 | 2343.5 | 2343.5 |
| Methane | 5903.8 | 10964.4 | 5903.8 | 5903.8 | 5903.8 | 10964.4 | 10964.4 |
| Ethane | 704.8 | 1309.0 | 704.8 | 704.8 | 704.8 | 1309.0 | 1309.0 |
| Propane | 286.4 | 531.9 | 286.4 | 286.4 | 286.4 | 531.9 | 531.9 |
| i-butane | 40.3 | 74.9 | 40.3 | 40.3 | 40.3 | 74.9 | 74.9 |
| Butane | 78.2 | 145.3 | 78.2 | 78.2 | 78.2 | 145.3 | 145.3 |
| i-pentane | 20.9 | 38.8 | 20.9 | 20.9 | 20.9 | 38.8 | 38.8 |
| Pentane | 21.0 | 39.1 | 21.0 | 21.0 | 21.0 | 39.1 | 39.1 |
| Hexane | 19.1 | 35.5 | 19.1 | 19.1 | 19.1 | 35.5 | 35.5 |
| Benzene | 0.4 | 0.8 | 0.4 | 0.4 | 0.4 | 0.8 | 0.8 |
| Heptane | 11.6 | 21.5 | 11.6 | 11.6 | 11.6 | 21.5 | 21.5 |
| Octane | 6.7 | 12.5 | 6.7 | 6.7 | 6.7 | 12.5 | 12.5 |
| H2O | 0.1 | 0.1 | 0.1 | 0.1 | 0.1 | 0.1 | 0.1 |
| Total flow rate | 8916.2 | 16558.9 | 8916.2 | 8916.2 | 8916.2 | 16558.9 | 16558.9 |
| in Kg mol/h | | | | | | | |
| Temperature, | 50.0 | 50.0 | −12.4 | −27.1 | −52.4 | −18.4 | −27.1 |
| in ° C. | | | | | | | |
| Pressure | 93.0 | 93.0 | 92.0 | 91.0 | 90.0 | 92.0 | 91.0 |
| in bar abs. | | | | | | | |

TABLE 4

| | Stream circulating in line | | | | | |
|---|---|---|---|---|---|---|
| | 19 | 20 | 21 | 22 | 23 | 24 |
| | PHASE | | | | | |
| | | | Vapor/ | | | |
| Fluid flow rate | | | liquid | | | |
| in Kg mol/h | Liquid | Liquid | mixture | Liquid | Vapor | Vapor |
| N2 | 223.0 | 343.0 | 343.0 | 3.1 | 339.9 | 339.9 |
| CO2 | 818.8 | 1259.7 | 1259.7 | 956.3 | 303.5 | 303.5 |
| H2S | 2343.5 | 3605.3 | 3605.3 | 3244.9 | 360.4 | 360.5 |
| Methane | 10964.4 | 16868.2 | 16868.2 | 4126.5 | 12741.7 | 12742.4 |
| Ethane | 1309.0 | 2013.8 | 2013.8 | 1683.5 | 330.4 | 330.4 |
| Propane | 531.9 | 818.3 | 818.3 | 782.7 | 35.6 | 35.6 |
| i-butane | 74.9 | 115.2 | 115.2 | 113.9 | 1.3 | 1.3 |
| Butane | 145.3 | 223.5 | 223.5 | 221.2 | 2.3 | 2.3 |
| i-pentane | 38.8 | 59.6 | 59.6 | 59.5 | 0.2 | 0.2 |
| Pentane | 39.1 | 60.1 | 60.1 | 59.9 | 0.2 | 0.2 |
| Hexane | 35.5 | 54.7 | 54.7 | 54.6 | 0.0 | 0.0 |
| Benzene | 0.8 | 1.2 | 1.2 | 1.2 | 0.0 | 0.0 |
| Heptane | 21.5 | 33.0 | 33.0 | 33.0 | 0.0 | 0.0 |
| Octane | 12.5 | 19.2 | 19.2 | 19.2 | 0.0 | 0.0 |
| H2O | 0.1 | 0.2 | 0.2 | 0.2 | 0.0 | 0.0 |
| Total flow rate | 16558.9 | 25475.1 | 25475.1 | 11359.7 | 14115.4 | 14116.3 |
| in Kg mol/h | | | | | | |
| Temperature, | −53.1 | −52.9 | −66.5 | −46.0 | −66.1 | 60.0 |
| in ° C. | | | | | | |
| Pressure | 90.0 | 90.0 | 44.0 | 44.3 | 44.0 | 95.0 |
| in bar abs. | | | | | | |

FIG. 3 shows an embodiment variant of the pretreating method described in connection with FIG. 2. The functions of the following elements: dehydration unit DH, heat exchangers E9, E10 and E11, expansion means V7 and drum B1 of FIG. 3 respectively correspond to the functions of the following elements: dehydration unit DH, heat exchangers E2, E3, E5, E6, R, expansion means V5 and column C1 of FIG. 2.

In FIG. 3, the crude effluent can be cooled by heat exchanger E8 and expanded by expansion means V6 prior to being fed into separation device S.

The associated gas discharged at the top of device S through line 31 is dehydrated in unit DH. According to the invention, the gas is dehydrated in unit DH in such a way that the water dew point of the dehydrated gas under the pressure conditions of drum B1 is higher by 15° C., preferably by 15° C. to 60° C., than the temperature of the effluent fed into drum B1 through line 42, i.e. the temperature of the effluent in drum B1.

The dehydrated effluent is separated into two streams circulating in lines 32 and 33. These streams are respectively cooled by heat exchangers E9 and E11. The two cooled streams are mixed. The resulting effluent is cooled by heat exchanger E11, then fed into heat exchanger E12 through line 41.

The effluent is then expanded in expansion means V7.

The expanded effluent is fed through line 42 into separator drum B1.

The liquid rich in acid compounds, essentially H₂S, is pumped by pump P4 and sent through line 44 to heat exchangers E12 and E10 to be heated again.

The H₂S-rich liquid is then pressurized, preferably by means of pumps (pump P5 for example), then fed into well P to be sequestered in a geologic structure or in an underground reservoir. Without departing from the scope of the invention, the H₂S-rich stream can be reinjected by any other known means.

The gas discharged at the top of drum B1 is heated in exchanger E9, compressed by compressor K2, then cooled by exchanger E13 and eventually sent by circulating in line 43 to a finishing treatment installation, onshore for example.

In order to illustrate the pretreating method described in connection with FIG. 3, an example of composition and of thermodynamic conditions of the streams circulating in the lines shown in FIG. 3 is given in Table 5. In this example, the thermodynamic conditions of drum B1 are so selected that the pretreated gas obtained at the top of drum B1 comprises less than 25% of the proportion of H₂S contained in the gas circulating in line 31.

TABLE 5

| | Stream circulating in line | | | | | | |
|---|---|---|---|---|---|---|---|
| | 31 | 32 | 33 | 41 | 42 | 43 | 44 |
| | PHASE | | | | | | |
| | | | | Vapor/ | | | |
| Fluid flow rate | | | | liquid | Vapor/liquid | | |
| in Kg mol/h | Vapor | Vapor | Vapor | mixture | mixture | Vapor | Liquid |
| N2 | 397.6 | 198.8 | 198.8 | 397.6 | 397.6 | 355.3 | 42.3 |
| CO2 | 1544.0 | 772.0 | 772.0 | 1544.0 | 1544.0 | 702.1 | 841.9 |
| H2S | 4628.9 | 2314.4 | 2314.4 | 4628.9 | 4628.9 | 1157.2 | 3471.6 |
| Methane | 19991.2 | 9995.6 | 9995.6 | 19991.2 | 19991.2 | 14696.0 | 5295.2 |
| Ethane | 2525.7 | 1262.8 | 1262.8 | 2525.7 | 2525.7 | 889.0 | 1636.7 |
| Propane | 1096.6 | 548.3 | 548.3 | 1096.6 | 1096.6 | 157.1 | 939.6 |
| i-butane | 161.5 | 80.8 | 80.8 | 161.5 | 161.5 | 8.4 | 153.1 |
| Butane | 323.1 | 161.5 | 161.5 | 323.1 | 323.1 | 16.1 | 307.0 |
| i-pentane | 90.1 | 45.0 | 45.0 | 90.1 | 90.1 | 1.6 | 88.5 |
| Pentane | 93.2 | 46.6 | 46.6 | 93.2 | 93.2 | 1.7 | 91.5 |
| Hexane | 87.0 | 43.5 | 43.5 | 87.0 | 87.0 | 0.3 | 86.7 |
| Benzene | 9.3 | 4.7 | 4.7 | 9.3 | 9.3 | 0.0 | 9.3 |
| Heptane | 52.8 | 26.4 | 26.4 | 52.8 | 52.8 | 0.0 | 52.8 |
| Octane | 55.9 | 28.0 | 28.0 | 55.9 | 55.9 | 0.0 | 55.9 |
| H2O | 129.7 | 1.5 | 1.5 | 3.0 | 3.0 | 0.1 | 2.8 |
| Total flow rate | 31186.7 | 15530.0 | 15530.0 | 31060.0 | 31060.0 | 17985.0 | 13075.0 |
| in Kg mol/h | | | | | | | |
| Temperature, | 65.0 | 67.2 | 67.2 | −20.9 | −39.1 | 65.0 | −32.1 |
| in ° C. | | | | | | | |
| Pressure | 95.0 | 95.0 | 95.0 | 93.0 | 55.0 | 95.0 | 150.0 |
| in bar abs. | | | | | | | |

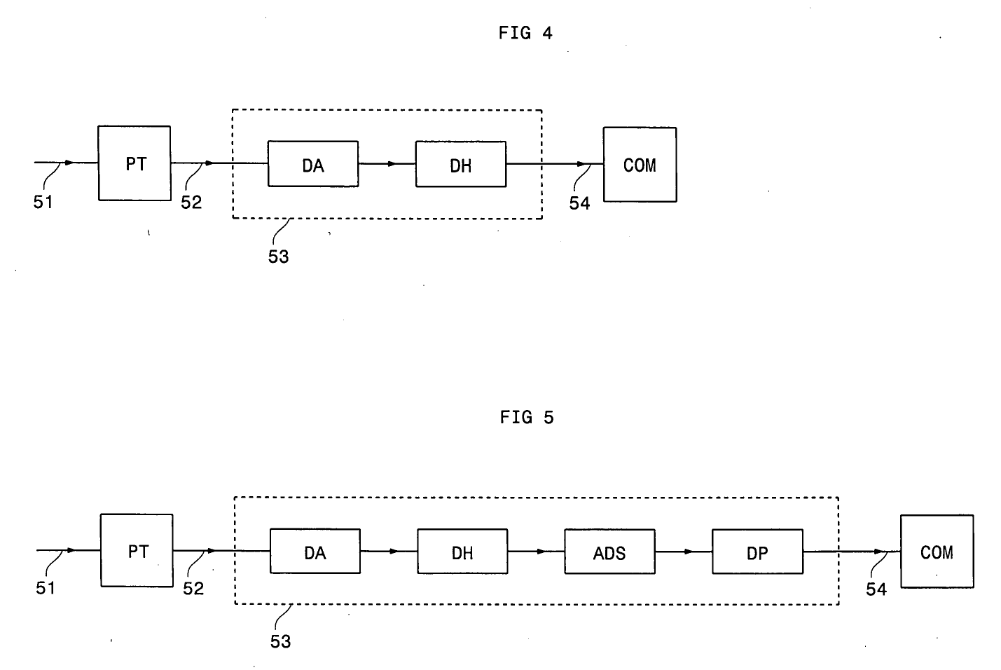

FIGS. 4 and 5 diagrammatically show the entire treatment of an acid gas.

In connection with FIG. 4, the gas flowing in through line 51 is subjected to a pretreatment in unit PT. This gas can correspond to the gas circulating in line 11 of FIG. 2 or to the gas circulating in line 31 of FIG. 3. This pretreatment can be carried out on the gas production site, for example the crude effluent extraction site, on an offshore platform, or a site located far from the main treating site. For example, the pretreatment can correspond to the method described in connection with FIG. 2 or 3.

Then, the pretreated gas from unit PT, for example the gas circulating in line 24 in FIG. 2 or in line 43 in FIG. 3, is circulated in line or pipe 52 to main treating unit 53, onshore for example.

In treating unit 53, the gas is subjected to deacidizing in unit DA. This deacidizing allows to remove residual acid compounds, in particular H₂S, possibly mercaptans, COS and CO₂. This treatment can be carried out by means of any treatment known to the man skilled in the art. It can be washing by means of a chemical, physical or hybrid solvent. Chemical solvents such as alkanolamines, for example monoethanolamine (MEA), diethanolamine (DEA), methyldiethanolamine (MDEA), diglycolamine (DGA), diisopropanolamine (DIPA) can be used. Physical solvents such as methanol, morpholines (N-formylmorpholine (NFM), N-acetylmorpholine, etc.), glycols (such as polyethylene glycol dimethylether) or N-methylpyrrolidone (NMP) can also be used. Finally, mixtures of chemical and/or physical solvents can be used. For example, unit DA can implement one of the methods described in the following documents: FR-2,605,241, FR-2,636,857, FR-2,743,083.

If the deacidizing treatment performed in unit DA leads to water saturation of the gas (notably with an amine treatment), a dehydration stage can be carried out in unit DH. The dehydration treatment performed in unit DH can be one of the dehydration treatments mentioned above in the description of unit DH of FIG. 2. In particular, it is possible to wash the gas with a glycol solution. The dehydrated gas is discharged from unit DH through line 54.

The treated gas from treating unit 53 can be used as fuel gas, for example for operation of unit 53. Part or all of the treated gas can be sent by circulating in line or pipe 54 to the upstream production site, offshore for example. The gas is then used as fuel in unit COM to produce energy, for example the energy required for operation of offshore production sites.

Table 6 illustrates the properties of the gas obtained at the outlet of unit DH of FIG. 4 by means of the method according to the invention and the properties required for a commercial gas. Case 1 corresponds to the treatment of a gas according to the method illustrated in FIG. 2 under the conditions stated in Tables 2 and 3. Case 2 corresponds to the treatment of a gas according to the method illustrated in FIG. 2 under the conditions stated in Tables 4 and 5.

TABLE 6

| | | | | Specifications |
|---|---|---|---|---|
| | | | | for a |
| Properties | Units | Case 1 | Case 2 | commercial gas |
| Gross heating value | MJ/Nm³ | 41.17 | 39.66 | 32.5 to 45 |
| (GHV) | | | | |
| Wobbe index | MJ/Nm³ | 53.16 | 52.10 | 41.2 to 54.5 |
| Water dew point | ° C. | <−30 | <−30 | <−30 |
| Hydrocarbon dew point | ° C. | −54.1 | −66.4 | <−30 |
| H₂S content | Mg/Nm³ | <7.0 | <7.0 | <7.0 |
| Mercaptan content | Mg/Nm³ | 6.4 | 0.7 | <14.0 |

The method according to the invention thus allows to provide a commercial gas or a fuel gas with limited additional treatments, as illustrated by FIG. 4. Additional demercaptanization and methane concentration treatments (operations commonly referred to as dew pointing) that are commonly carried out on the sweet gas downstream from the deacidizing treatment in unit DA, and illustrated in FIG. 5, are thus unnecessary.

FIG. 5 is an alternative to the gas treatment described in connection with FIG. 4. The reference numbers of FIG. 5 identical to those of FIG. 4 designate the same elements.

In connection with FIG. 5, the gas undergoes a partial deacidizing pretreatment in unit PT, then it is deacidized in unit DA and dehydrated in unit DH.

The dehydrated gas is subjected to an additional acid compound adsorption treatment in unit ADS, notably if a high proportion of mercaptans is present in the gas. Unit ADS can implement a treatment on zeolites, for example the method described in document WO-2004/039,926 A1.

Furthermore, the mercaptan-depleted gas from ADS is subjected to an adjustment of the hydrocarbon composition thereof by cooling the gas to a predetermined temperature in order to condense the unwanted hydrocarbons. This operation is commonly referred to as dew pointing.

The sweet gas is sent to unit COM.

Without departing from the scope of the invention, the method according to the invention can be used for pretreatment of any type of hydrocarbon gas comprising H₂S.

1) A method for treating a hydrocarbon gas, said gas comprising at least one of the acid compounds as follows: hydrogen sulfide (H₂S), carbon dioxide (CO₂), carbon oxysulfide (COS) and mercaptans, wherein the following stages are carried out:
a) dehydrating the gas,
b) cooling the dehydrated gas to a temperature at which part of the acid compounds condense, so as to obtain an effluent comprising a liquid fraction rich in acid compounds and a gaseous fraction depleted in acid compounds,
c) sending the effluent to a separation zone so as to separate the liquid fraction from the gaseous fraction,
d) injecting at least part of the liquid fraction rich in acid compounds into an underground storage zone,
and wherein, in stage a), the gas is dehydrated so that the water dew point temperature of the dehydrated gas at the operating pressure of the separation zone is higher by at least 15° C. than the minimum temperature of said effluent in the separation zone.

2) A method as claimed in claim 1, wherein:
said gas is at a pressure ranging between 30 and 120 bar absolute,
the water content of the dehydrated gas obtained in stage a) is below 50 ppm,
in stage b), the dehydrated gas is cooled to a temperature ranging between −90° C. and −20° C.

3) A method as claimed in claim 1, wherein additional deacidizing of the gaseous fraction obtained in stage c) is carried out by absorption of the acid compounds by an absorbent solution and/or by adsorption of the acid compounds on a molecular sieve.

4) A method as claimed in claim 3, wherein the deacidized gaseous fraction is dehydrated.

5) A method as claimed in claim 1 wherein, in stage c), the separation zone uses one of the following means: distillation column, separator drum.

6) A method as claimed in claim 5, wherein part of the gaseous fraction from the distillation column is condensed by cooling, then fed into the column as reflux.

7) A method as claimed in claim 1 wherein, in stage b), the gas is cooled by means of at least one of the following methods: heat exchange and expansion.

8) A method as claimed in claim 1 wherein, prior to stage d), the pressure of said at least part of the H₂S-rich liquid fraction is raised by pumping.

9) A method as claimed in claim 1, wherein the hydrocarbon gas is a gas associated with a crude petroleum effluent and wherein, prior to stage a), the crude petroleum effluent and the associated gas are separated.

10) A method as claimed in claim 9 wherein, prior to separation, the crude petroleum effluent is expanded and/or cooled before it is separated from the associated gas.

11) A method as claimed in 9, wherein the crude petroleum effluent is extracted from an offshore oil structure and wherein the gaseous fraction is deacidized in an onshore treating zone.

12) A method as claimed in claim 11, wherein the deacidized gaseous fraction is sent back to the platform to be used as fuel.
